(19) United States
(12) Patent Application Publication
(10) Pub. No.: US 2014/0329511 A1
(43) Pub. Date: Nov. 6, 2014

(54) AUDIO CONFERENCING

(71) Applicants: Sampo Vesa, Helsinki (FI); Jussi Virolainen, Espoo (FI)

(72) Inventors: Sampo Vesa, Helsinki (FI); Jussi Virolainen, Espoo (FI)

(73) Assignee: Nokia Corporation, Espoo (FI)

(21) Appl. No.: 14/365,353

(22) PCT Filed: Dec. 20, 2011
(86) PCT No.: PCT/FI2011/051139

§ 371 Date: Jun. 13, 2014

(51) Int. Cl. H04M 3/56; H04W 4/16

(52) U.S. Cl. CPC H04M 3/568; H04W 4/16
USPC 455/416

(57) ABSTRACT

The invention relates to audio conferencing. Audio signals are received and transformed to a spectrum, and then modified by mel-frequency scaling and logarithmic scaling before a second-order transform. The obtained coefficients can be further processed before carrying out the similarity comparison between signals. Voice activity detection and other information like mute signalling can be used in the formation of the similarity information. The resulting similarity information can be used to form groups, and the resulting groups can be analyzed topologically. The similarity information can then be used to form a control signal for audio conferencing, e.g. to control an audio conference so that a signal of a co-located audio source is removed.

### BACKGROUND

Audio conferencing offers the possibility of several people sharing their thoughts in a group without being physically in the same location. With the more widespread used of mobile communication devices and with the increase in their capabilities, audio conferencing has become possible in new environments which may present new requirements for the audio conferencing solution. Also, audible phenomena like unwanted feedback have become more difficult to manage, because people with mobile communication devices can be located practically anywhere and two people in the same audio conference may actually be co-located in the same space, thereby giving rise to such unwanted phenomena.

There is, therefore, a need for audio conferencing solutions with improved handling of the conference audio signals.

### SUMMARY

Now there has been invented an improved method and technical equipment implementing the method, by which e.g. the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

The invention relates to audio conferencing. Audio signals are received and transformed to a spectrum, and may then be modified e.g. by mel-frequency scaling and logarithmic scaling before a second-order transform such as a discrete cosine transform or another decorrelating transform. In other words, coefficients like mel-frequency cepstral coefficients may be formed. The obtained coefficients can be further processed before carrying out the similarity comparison between signals. For example, voice activity detection and other information like mute signaling and simultaneous talker information can be used in the formation of the similarity information. Also delay and hysteresis can be applied to improve the stability of the system. The resulting similarity information can be used to form groups, and the resulting groups can be analyzed topologically e.g. to connect two audio sources to the same group that were not indicated to belong to the same group by similarity but that share a neighbor in the group. The similarity information can then be used to form a control signal for audio conferencing, e.g. to control audio mixing in an audio conference so that a signal of a co-located audio source is removed. This may prevent the sending of an audio signal through the conference to a listener that is able to hear the signal directly due to presence in the same acoustic space. Phenomena like unwanted feedback may thus also be avoided. In addition, new uses of audio conferencing may be enabled such as distributed audio conferencing, where several devices in the same room can act as sources in the conference to improve audio quality, or persistent communication, where users stay in touch with each other for prolonged times while e.g. moving around.

According to a first aspect there is provided a method, comprising receiving first and second second-order spectrum coefficients for a first audio signal from a first device and a second audio signal from a second device, determining a similarity of said first and second-order spectrum coefficients, and forming a control signal using said similarity, said control signal for controlling audio conferencing.

According to an embodiment, the method comprises receiving a first audio signal from a first device and a second audio signal from a second device, computing first and second power spectrum coefficients from said first and second audio signals, respectively, by applying a transform to said audio signals, computing first and second second-order spectrum coefficients from said first and second power spectrum coefficients, respectively, by applying a transform to said power spectrum coefficients, determining a similarity of said first and second second-order spectrum coefficients, and using said similarity in controlling said conferencing.

According to an embodiment, said second-order spectrum coefficients are mel-frequency cepstral coefficients. According to an embodiment, the method comprises scaling said second-order spectrum coefficients with an increasing function so that values of higher-order coefficients are increased more than values of lower-order coefficients. According to an embodiment, said function is a liftering function, and said coefficients are scaled according to equation Cscaled=Coriginal*k̂a, where Cscaled is the scaled coefficient value, Coriginal is the original coefficient value, k is the order of the coefficient and a is an exponent such as 0.4. According to an embodiment, the method comprises omitting at least one second-order spectrum coefficient in determining said similarity, said omitted coefficient being indicative of a long-term mean power of said signals. According to an embodiment, the method comprises determining said similarity by computing a forgetting time-average of a dot product between said first and second second-order spectrum coefficients. According to an embodiment, the method comprises computing time averages of said first and second second-order spectrum coefficients, subtracting said time averages from said second-order spectrum coefficients prior, and using the subtracted coefficients in determining said similarity. According to an embodiment, the method comprises forming an indication of co-location of said first and said second device using said similarity, and controlling said conferencing so that said co-location is taken into account in processing said first and second audio signals for said first and second device.

According to an embodiment, the method comprises using information from a voice activity detection of at least one audio signal in forming said indication of co-location. According to an embodiment, a plurality of audio signals from a plurality of devices in addition to the first and second audio signals are received and analyzed for forming a plurality of indications of co-location of two or more devices, and the method comprises analyzing the topology of co-location indicators so that if said first device and said second device are indicated to be co-located, and said first device and a third device are indicated to be co-located, an indication is formed for the second device and the third device to be co-located.

According to an embodiment, the method comprises forming topological groups using said indications of co-location of devices, and controlling said conferencing using said topological groups. According to an embodiment, the method comprises delaying a change in indication of co-location e.g by applying delay to forming said indication of co-location. According to an embodiment, the method comprises using mute-status signalling for avoidance of indicating that said first and second devices are not co-located in case at least one of said first and second devices is in mute state. According to an embodiment, the method comprises detecting a presence of more than one concurrent speaker, and based on said detection of concurrent speakers, preventing modification of at least one indication of co-location. According to an embodiment, the method comprises detecting movement or location of at least one speaker or device, and using said movement or location detection in determining of at least one indication of co-location.

According to a second aspect there is provided an apparatus comprising at least one processor, memory, operational units, and computer program code in said memory, said computer program code being configured to, with the at least one processor, cause the apparatus at least to receive first and second second-order spectrum coefficients for a first audio signal from a first device and a second audio signal from a second device, determine a similarity of said first and second second-order spectrum coefficients, and form a control signal using said similarity, said control signal for controlling audio conferencing.

According to an embodiment, the apparatus comprises computer program code being configured to cause the apparatus to receive a first audio signal from a first device and a second audio signal from a second device, compute first and second power spectrum coefficients from said first and second audio signals, respectively, by applying a transform to said audio signals, compute first and second second-order spectrum coefficients from said first and second power spectrum coefficients, respectively, by applying a transform to said power spectrum coefficients, determine a similarity of said first and second second-order spectrum coefficients, and use said similarity in controlling said conferencing.

According to an embodiment, the second-order spectrum coefficients are mel-frequency cepstral coefficients. According to an embodiment, the apparatus comprises computer program code being configured to cause the apparatus to scale said second-order spectrum coefficients with an increasing function so that values of higher-order coefficients are increased more than values of lower-order coefficients. According to an embodiment, the function is a liftering function, and said coefficients are scaled according to equation Cscaled=Coriginal*k̂a, where Cscaled is the scaled coefficient value, Coriginal is the original coefficient value, k is the order of the coefficient and a is an exponent such as 0.4. According to an embodiment, the apparatus comprises computer program code being configured to cause the apparatus to omit at least one second-order spectrum coefficient in determining said similarity, said omitted coefficient being indicative of a long-term mean power of said signals. According to an embodiment, the apparatus comprises computer program code being configured to cause the apparatus to determine said similarity by computing a forgetting time-average of a dot product between said first and second second-order spectrum coefficients. According to an embodiment, the apparatus comprises computer program code being configured to cause the apparatus to compute time averages of said first and second second-order spectrum coefficients, subtract said time averages from said second-order spectrum coefficients prior, and use the subtracted coefficients in determining said similarity. According to an embodiment, the apparatus comprises computer program code being configured to cause the apparatus to form an indication of co-location of said first and said second device using said similarity, control said conferencing so that said co-location is taken into account in processing said first and second audio signals for said first and second device.

According to an embodiment, the apparatus comprises computer program code being configured to cause the apparatus to use information from a voice activity detection of at least one audio signal in forming said indication of co-location. According to an embodiment, a plurality of audio signals from a plurality of devices in addition to the first and second audio signals are received and analyzed for forming a plurality of indications of co-location of two or more devices, and the apparatus comprises computer program code being configured to cause the apparatus to analyze the topology of co-location indicators so that if said first device and said second device are indicated to be co-located, and said first device and a third device are indicated to be co-located, an indication is formed for the second device and the third device to be co-located.

According to an embodiment, the apparatus comprises computer program code being configured to cause the apparatus to form topological groups using said indications of co-location of devices, and control said conferencing using said topological groups. According to an embodiment, the apparatus comprises computer program code being configured to cause the apparatus to delay a change in indication of co-location e.g by applying delay to forming said indication of co-location. According to an embodiment, the apparatus comprises computer program code being configured to cause the apparatus to use mute-status signaling for avoidance of indicating that said first and second devices are not co-located in case at least one of said first and second devices is in mute state. According to an embodiment, the apparatus comprises computer program code being configured to cause the apparatus to detect a presence of more than one concurrent speaker, and based on said detection of concurrent speakers, prevent modification of at least one indication of co-location. According to an embodiment, the apparatus comprises computer program code being configured to cause the apparatus to detect movement or location of at least one speaker or device, and use said movement or location detection in determining of at least one indication of co-location.

According to a third aspect there is provided a system comprising at least one processor, memory, operational units, and computer program code in said memory, said computer program code being configured to, with the at least one processor, cause the system to carry out the method according to the first aspect and its embodiments.

According to a fourth aspect there is provided an apparatus comprising means for receiving first and second second-order spectrum coefficients for a first audio signal from a first device and a second audio signal from a second device, means for determining a similarity of said first and second second-order spectrum coefficients, and means for forming a control signal using said similarity, said control signal for controlling audio conferencing.

According to an embodiment, the apparatus comprises means for receiving a first audio signal from a first device and a second audio signal from a second device, means for computing first and second power spectrum coefficients from said first and second audio signals, respectively, by applying a transform to said audio signals, means for computing first and second second-order spectrum coefficients from said first and second power spectrum coefficients, respectively, by applying a transform to said power spectrum coefficients, means for determining a similarity of said first and second second-order spectrum coefficients, and means for using said similarity in controlling audio conferencing.

According to an embodiment, said second-order spectrum coefficients are mel-frequency cepstral coefficients. According to an embodiment, the apparatus comprises means for scaling said second-order spectrum coefficients with an increasing function so that values of higher-order coefficients are increased more than values of lower-order coefficients. According to an embodiment, said function is a liftering function, and said coefficients are scaled according to equation Cscaled=Coriginal*k̂a, where Cscaled is the scaled coefficient value, Coriginal is the original coefficient value, k is the order of the coefficient and a is an exponent such as 0.4. According to an embodiment, the apparatus comprises means for omitting at least one second-order spectrum coefficient in determining said similarity, said omitted coefficient being indicative of a long-term mean power of said signals. According to an embodiment, the apparatus comprises means for determining said similarity by computing a forgetting time-average of a dot product between said first and second second-order spectrum coefficients. According to an embodiment, the apparatus comprises means for computing time averages of said first and second second-order spectrum coefficients, means for subtracting said time averages from said second-order spectrum coefficients prior, means for using the subtracted coefficients in determining said similarity. According to an embodiment, the apparatus comprises means for forming an indication of co-location of said first and said second device using said similarity, means for controlling said conferencing so that said co-location is taken into account in processing said first and second audio signals for said first and second device. According to an embodiment, the apparatus comprises means for using information from a voice activity detection of at least one audio signal in forming said indication of co-location. According to an embodiment, the apparatus comprises means for receiving and analyzing a plurality of audio signals from a plurality of devices in addition to the first and second audio signals for forming a plurality of indications of co-location of two or more devices, and means for analyzing the topology of co-location indicators so that if said first device and said second device are indicated to be co-located, and said first device and a third device are indicated to be co-located, an indication is formed for the second device and the third device to be co-located.

According to an embodiment, the apparatus comprises means for forming topological groups using said indications of co-location of devices, and means for controlling said conferencing using said topological groups. According to an embodiment, the apparatus comprises means for delaying a change in indication of co-location e.g by applying delay to forming said indication of co-location. According to an embodiment, the apparatus comprises means for using mute-status signalling for avoidance of indicating that said first and second devices are not co-located in case at least one of said first and second devices is in mute state. According to an embodiment, the apparatus comprises means for detecting a presence of more than one concurrent speaker, and means for based on said detection of concurrent speakers, preventing modification of at least one indication of co-location. According to an embodiment, the apparatus comprises means for detecting movement or location of at least one speaker or device, and means for using said movement or location detection in determining of at least one indication of co-location.

According to a fifth aspect, there is provided a computer program product stored on a non-transitory computer readable medium and executable in a data processing apparatus, the computer program product comprising a computer program code section for receiving first and second second-order spectrum coefficients for a first audio signal from a first device and a second audio signal from a second device, a computer program code section for determining a similarity of said first and second second-order spectrum coefficients, and a computer program code section for forming a control signal using said similarity, said control signal for controlling audio conferencing.

According to a sixth aspect there is provided a computer program product stored on a non-transitory computer readable medium and executable in a data processing apparatus, the computer program product comprising a computer program code section for receiving a first audio signal from a first device and a second audio signal from a second device, a computer program code section for computing first and second power spectrum coefficients from said first and second audio signals, respectively, by applying a transform to said audio signals, a computer program code section for computing first and second second-order spectrum coefficients from said first and second power spectrum coefficients, respectively, by applying a transform to said power spectrum coefficients, a computer program code section for determining a similarity of said first and second second-order spectrum coefficients, and a computer program code section for using said similarity in controlling audio conferencing.

According to a seventh aspect there is provided a computer program product stored on a non-transitory computer readable medium and executable in a data processing apparatus, the computer program product comprising computer program code sections for carrying out the method steps according to the first aspect and its embodiments.

### DESCRIPTION OF THE DRAWINGS

In the following, various embodiments of the invention will be described in more detail with reference to the appended drawings, in which

FIG. 1 shows a flow chart of a method for audio conferencing according to an embodiment;

FIGS. 2a and 2b shows a system and devices for audio conferencing according to an embodiment;

FIGS. 3a and 3b Illustrate an audio conferencing arrangement according to an embodiment;

FIG. 4 shows a block diagram for forming a control signal for controlling an audio conference according to an embodiment;

FIGS. 5a and 5b show the use of topology analysis according to an embodiment;

FIGS. 6a, 6b and 6c illustrate signal processing for controlling an audio conference according to an embodiment; and

FIG. 7 shows a flow chart for a method for audio conferencing according to an embodiment.

### DESCRIPTION OF THE EXAMPLE EMBODIMENTS

In the following, several embodiments will be described in the context of audio conferencing. It is to be noted, however, that the invention is not limited to audio conferencing, but can be used in other contexts like persistent communication. In fact, the different embodiments have applications in any environment where improved processing of audio from multiple sources is required.

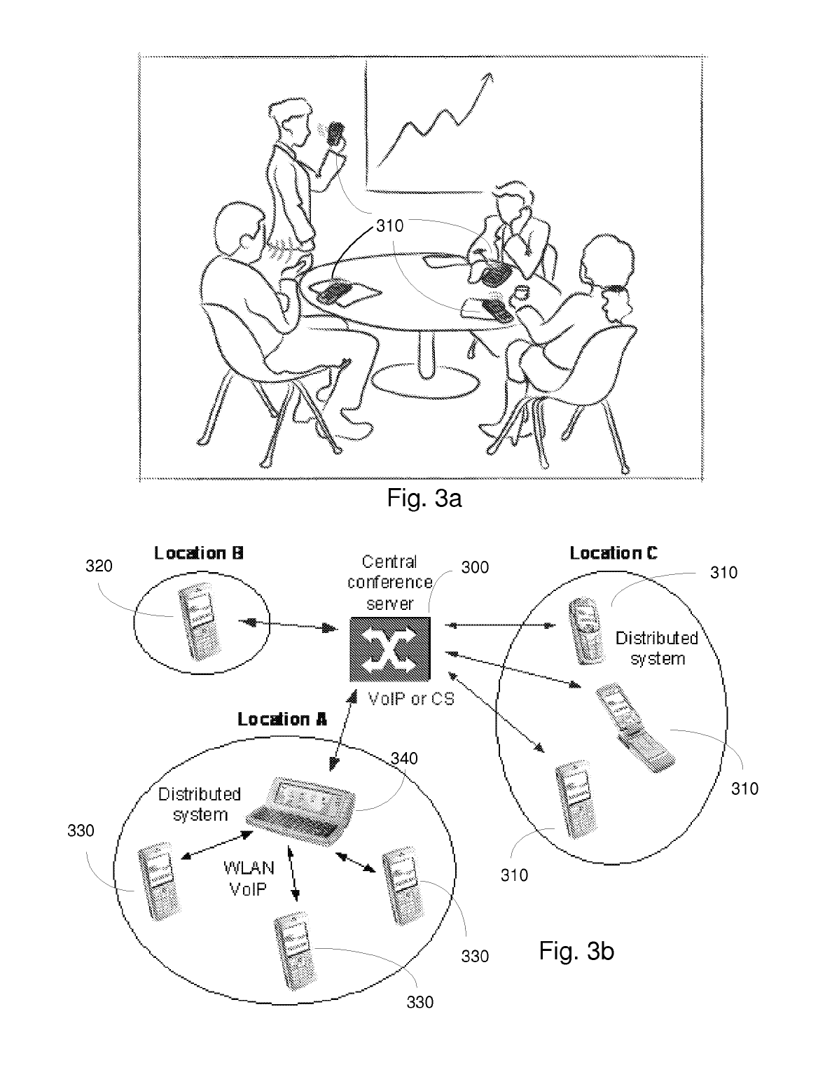

Various embodiments have applications in the field of audio conferencing, e.g. distributed teleconferencing. The concept of distributed teleconferencing such as shown in FIG. 3 means that people located in the same acoustical space (conference room) participate in a teleconference session each using their own mobile device as their personal microphone and loudspeaker.

Various embodiments have applications in the field of persistent communication using mobile devices. In persistent communication, the connection between devices is continuous. This allows the users to interact more freely and spontaneously. The modality of communication can be e.g. auditory, visual, haptic, or a combination of any of these. Various embodiments relate to multi-party persistent communication in the auditory modality using mobile devices. The captured sound streams may be routed by a server device, which can be the device of one of the participants or a dedicated server machine.

Various embodiments have applications in the field of augmented reality audio (ARA), which is basically augmented reality (AR) in the auditory modality. A special ARA headset may be used to permit hearing the surrounding sound environment with augmented sound events rendered on top of it. One application of ARA is that of communication. Because the headset does not disturb the perception of the surrounding environment, it could be worn for long periods of time. This makes it ideal for sound-based persistent communication scenarios with multiple participants.

In various embodiments, a method is presented which gives a binary decision—i.e. a control signal—of whether or not two users are in the same acoustic space at the current time instant. The decision may e.g. based on the acoustic signals captured by the devices of the two users. Based on the e.g. pair-wise decisions, multiple users are grouped by finding the connected components of the graph, each of which corresponds to a group of users sharing the same acoustic space. A control signal based on the decisions and e.g. the graph processing can be formed for controlling e.g. audio mixing or other aspects in an audio conference. The various embodiments thus offer improvements to participating in a voice conference session using multiple mobile devices simultaneously in the same acoustic space.

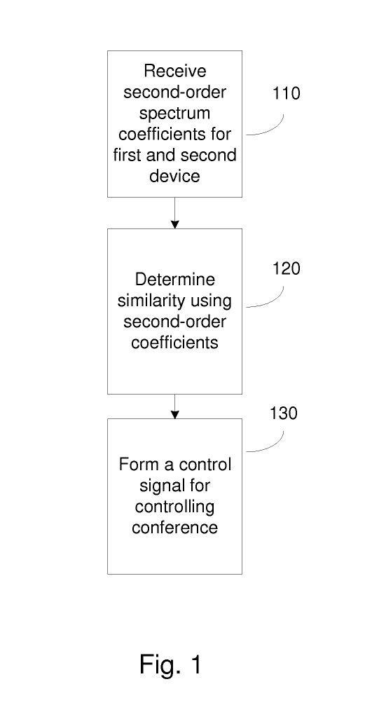

FIG. 1 shows a flow chart of a method for audio conferencing according to an embodiment. In phase 110, second-order spectrum coefficients may be received, where the coefficients have been formed from audio signals received at multiple devices. For example, audio signals may be picked by microphones at multiple mobile communication devices, and then transformed with a first and second transform to obtain second-order transform coefficients. This dual transform may be e.g. mel-frequency cepstral transform resulting in mel-frequency cepstral coefficients. The transform may be carried out partly or completely at the mobile devices where the audio signal is captured, and/or it may be carried out at a central computer such as an audio conference server. The coefficients from the second-order transform are then received for processing in phase 110.

In phase 120, the coefficients are used to determine similarity between the audio signals from which they originate. For example, the similarity may indicate the presence of two devices in the same acoustic space. The similarity may be formed as a pair-wise correlation between two sets of transform coefficients, or another similarity measure such as a normalized dot product or normalized or un-normalized distance of any kind. The similarity may be given e.g. as a number varying between 0 and 1.

In phase 130, a control signal is formed from the similarity so that an audio conference may be controlled using the control signal. For example, a binary value whether two devices are in the same acoustic space may be given, and this value may then be used to suppress the audio signals from these devices to each other to prevent unwanted behavior such as unwanted audio feedback. Other information such as mute status signals and voice activity detection signals may be used in the formation of the control signal from the similarity.

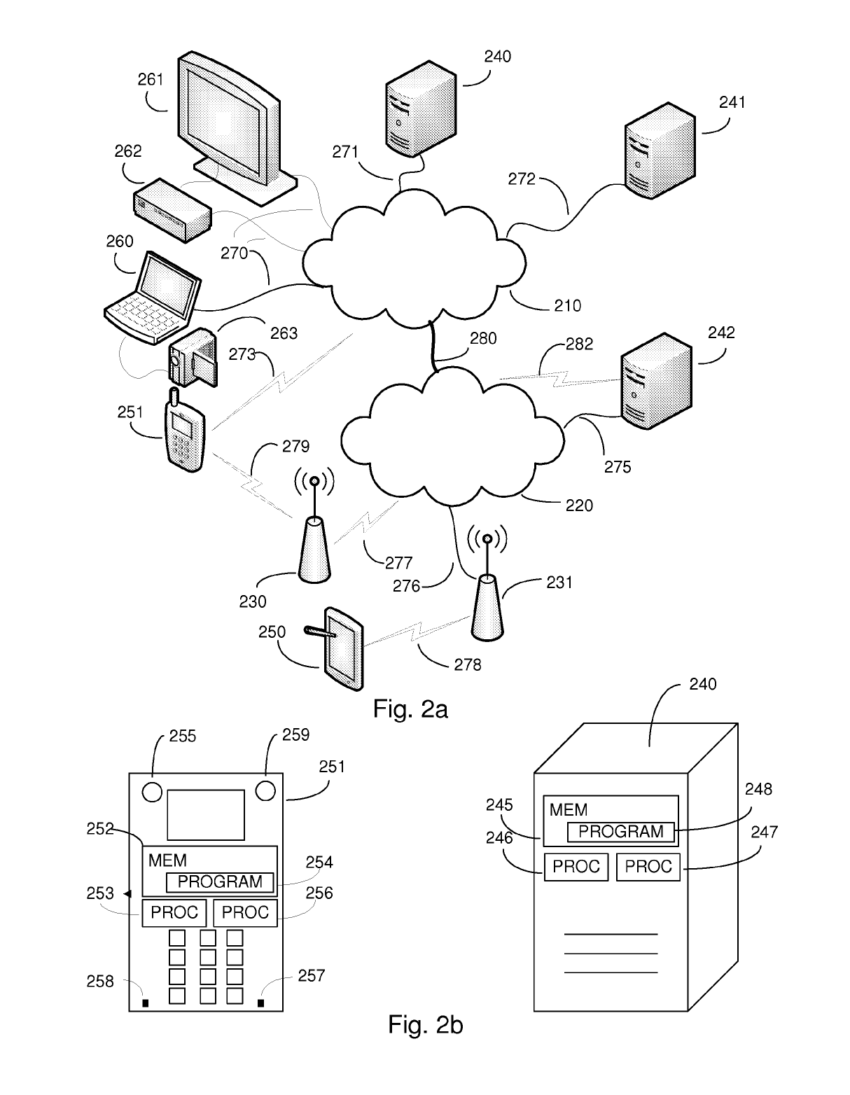

FIGS. 2a and 2b show a system and devices for audio conferencing according to an embodiment.

In FIG. 2a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 2a are shown a server 240 for acting as a conference bridge and connected to the fixed network 210, a server 241 for carrying audio signal processing and connected to the fixed network 210, and a server 242 for acting as a conference bridge and connected to the mobile network 220. Some of the above devices, for example the servers 240, 241, 242 may be such that they make up the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders such as digital microphones for audio capture. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices where audio conferencing may be carried out according to an example embodiment. As shown in FIG. 2b, the server 240 contains memory 245, one or more processors 246, 247, and computer program code 248 residing in the memory 245 for implementing, for example, the functionalities of a software application like an audio conference bridge or video conference service. The different servers 240, 241, 242 may contain at least these same elements for employing functionality relevant to each server. Similarly, the end-user device 251 contains memory 252, at least one processor 253 and 256, and computer program code 254 residing in the memory 252 for implementing, for example, the functionalities of a software application like a audio processing and audio conferencing. The end-user device may also have one or more cameras 255 and 259 for capturing image data, for example video. The end-user device may also contain one, two or more microphones 257 and 258 for capturing sound. The end-user devices may also have one or more wireless or wired microphones attached thereto. The different end-user devices 250, 260 may contain at least these same elements for employing functionality relevant to each device. The end user devices may also comprise a screen for viewing a graphical user interface.

It needs to be understood that different embodiments allow different parts to be carried out in different elements. For example, execution of a software application may be carried out entirely in one user device like 250, 251 or 260, or in one server device 240, 241, or 242, or across multiple user devices 250, 251, 260 or across multiple network devices 240, 241, or 242, or across both user devices 250, 251, 260 and network devices 240, 241, or 242. For example, the capturing and digitization of audio signals may happen in one device, the audio signal processing into transform coefficients may happen in another device and the control and management of audio conferencing may be carried out in a third device. The different application elements and libraries may be implemented as a software component residing on one device or distributed across several devices, as mentioned above, for example so that the devices form a so-called cloud. A user device 250, 251 or 260 may also act as a conference server, just like the various network devices 240, 241 and 242. The functions of this conference server i.e. conference bridge may be distributed across multiple devices, too.

The different embodiments may be implemented as software running on mobile devices and optionally on devices offering network-based services. The mobile devices may be equipped at least with a memory, processor, display, keypad, motion detector hardware, and communication means such as 2G, 3G, WLAN, or other. The different devices may have hardware like a touch screen (single-touch or multi-touch) and means for positioning like network positioning or a global positioning system (GPS) module. There may be various applications on the devices such as a calendar application, a contacts application, a map application, a messaging application, a browser application, a gallery application, a video player application and various other applications for office and/or private use.

FIGS. 3a and 3b illustrate an audio conferencing arrangement according to an embodiment. The concept of distributed teleconferencing may be understood to mean that people located in the same acoustical space (conference room) as in FIG. 3a are participating in a teleconference session each using their own mobile device 310 as their personal microphone and loudspeaker. For example, ways to setup a distributed conference call are as follows.

1) A wireless network is formed between the mobile devices 330 and 340 that are in the same conference room (FIG. 3b location A). One of the devices 340 acts as a (e.g. local) host device which connects to both the local terminals 330 in the same room and a conference switch 300 (or a remote participant). The host device receives microphone signals from all the other devices in the room. The host device runs a mixing algorithm that generates an enhanced uplink signal from the microphone signals. In the downlink direction, the host device receives the speech signal from the network and shares this signal to be reproduced by the hands-free loudspeakers of the all devices in the room. Individual participating devices 310 and 320 can connect to the conference bridge directly, too.
2) A conference bridge 300 which is a part of the network infrastructure can implement distributed conferencing functionality, FIG. 3b: location C. There, participants 310 call to the conference bridge and either the conference bridge detects automatically which participants are in same acoustic space.

Distributed conferencing may improve speech quality in the far-end side, since microphones are near the participants. At the near-end side, less listening effort is required from the listener when multiple loudspeakers are used to reproduce the conference speech. Use of several loudspeakers may also reduce distortion levels, since loudspeaker output can be kept at lower level compared with using only one loudspeaker. Distributed conference audio makes it possible to detect who is currently speaking in the conference room.

If the participants in an audio-based persistent communication are free to move as they wish, it is possible that two or more of them are present in the same acoustic space. In order to avoid disturbing echoes, the users in the same acoustic space should not hear each others' audio streams via the network, as they can hear each other acoustically. Therefore it has been noticed in the invention that the other participants' audio signals may be cut out to improve audio quality. It is convenient to automatically recognize, which users are in the same acoustic space at a certain time. The various embodiments provide for this by presenting an algorithm that groups together users that are present in the same acoustic space at each time instant, based on the acoustic signals captured by the devices of the users.

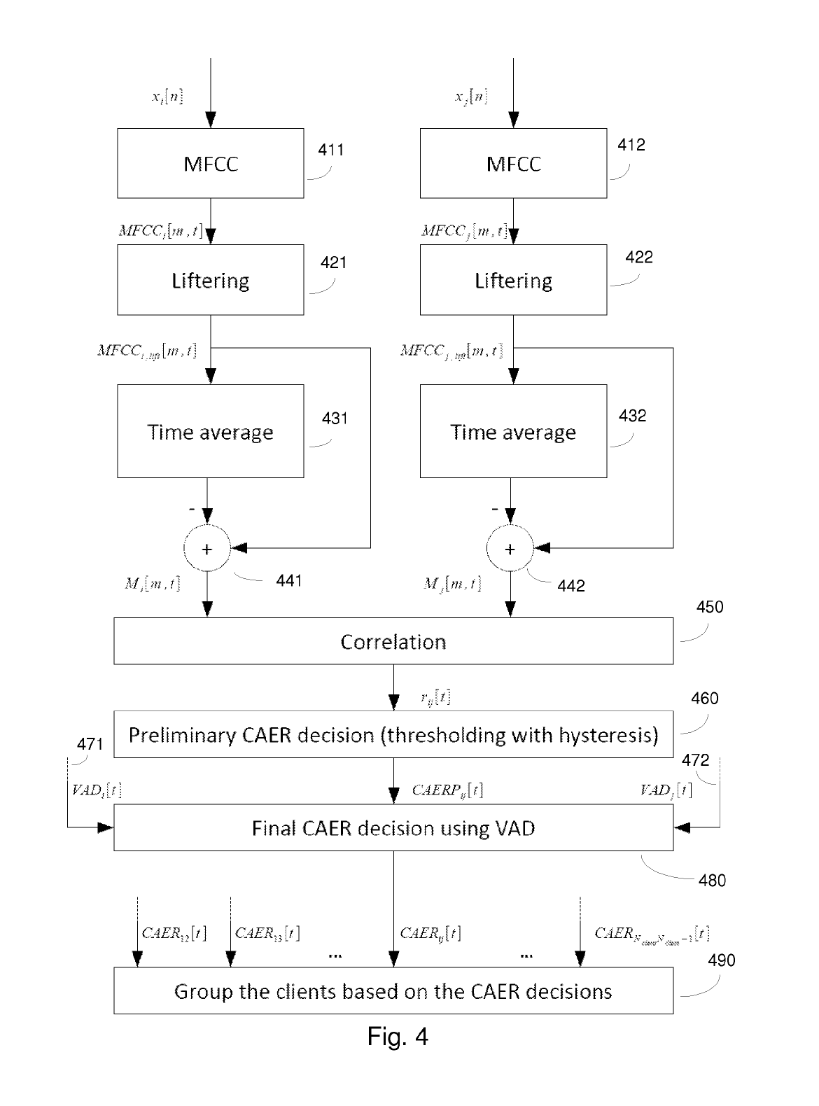

FIG. 4 shows a block diagram for forming a control signal for controlling an audio conference according to an embodiment. First, a method for detecting that two signals are from a common acoustic environment, that is, the common acoustic environment recognition (CAER) algorithm is described according to an embodiment.

First, signals xᵢ[n] and xⱼ[n] are received, e.g. by sampling and digitizing a signal using a microphone and a sampler and a digitizer, possibly in the same electronic element. In blocks 411 (for the first signal i) and 412 (for the second signal j) mel-frequency cepstral coefficients (MFCCs) may be computed from each user's transmitted microphone signal. Pre-emphasized short-time signal frames (˜20 ms) with no overlap may be used, for example, for forming the coefficients. Other forms of first and second order transforms may be applied, and using mel-frequency cepstral coefficients may offer the advantage that such processing capabilities may be present in a device for e.g. speech recognition purposes (MFCCs are often used in speech recognition). The forming of the MFCCs may happen at a terminal device or at the conference bridge, or at another device.

In blocks 412 and 422, the MFCCs may be scaled with a liftering function using

MFCC_{lift}[m,t]=MFCC[m,t]·m^{α} for m=1,2, . . . ,K,

where K is the number of MFCC coefficients (for example 13), α is an exponent (for example α=0.4), and t is the signal frame index. The 0th energy-dependent coefficient may be omitted in this algorithm. The purpose of this liftering pre-processing step is to scale the MFCCs so that their value ranges are comparable later when computing correlations. In other words, the different MFCC values have typically different ranges, but liftering makes them more equal in range, and thus the different MFCC coefficients receive more equal weight in the similarity determination.

In blocks 431 and 432, the time average of the scaled MFCCs may be computed using a leaky integrator (<MFCC_{lift}[m,t]> are initialized to zero in the beginning) according to the equation

<MFCC_{lift}[m,t]>=β·<MFCC_{lift}[m,t−1]>+(1−β)·MFCC_{lift}[m,t],

where βε[0,1] is the forgetting factor.

In blocks 441 and 442, the time average may be subtracted completely or partly from the liftered MFCCs (cepstral mean subtraction, CMS) in order to reduce the effects of different time-invariant channels (e.g. different transducer and microphone responses in different device models) according to the equation

MFCC_{CMS}[m,t]=MFCC_{lift}[m,t]−<MFCC_{lift}[m,t]>.

In block 450, for different user pairs (i,j), the correlation rᵢⱼ may be computed as follows (the c variables are set to zero in the beginning):

$$a . {c}_{ii} [ m , t ] = β \cdot {c}_{ii} [ m , t - 1 ] + ( 1 - β ) \cdot {MFCC}_{CMS , i} [ m , t ] \cdot {MFCC}_{CMS , i} [ m , t ]$$

$$b . {c}_{jj} [ m , t ] = β \cdot {c}_{jj} [ m , t - 1 ] + ( 1 - β ) \cdot {MFCC}_{CMS , j} [ m , t ] \cdot {MFCC}_{CMS , j} [ m , t ]$$

$$c . {c}_{ij} [ m , t ] = β \cdot {c}_{ij} [ m , t - 1 ] + ( 1 - β ) \cdot {MFCC}_{CMS , i} [ m , t ] \cdot {MFCC}_{CMS , j} [ m , t ]$$

$$d . {r}_{i , j} [ t ] = \frac{{\sum }_{m = 1}^{K} {c}_{ij} [ m , t ]}{\sqrt{{\sum }_{m = 1}^{K} {c}_{ii} [ m , t ] \cdot {\sum }_{m = 1}^{`K} {c}_{jj} [ m , t ]}}$$

In block 460, a preliminary CAER decision CAERPᵢⱼ may be formed. The normalized correlation r may be thresholded using hysteresis in order to preliminarily decide, whether or not the two users are located in the same acoustic space at time step t (CAERPᵢⱼ[t] is the preliminary binary decision at time step t for clients i and j, T is the threshold and H is the hysteresis) according to

| | |
|---|---|
| a. | If (rᵢⱼ[t−1] < T + H) AND (rᵢⱼ[t] >= T + H): CAERPᵢⱼ[t] = 1 |
| b. | Else if (rᵢⱼ[t−1] > T − H) AND (rᵢⱼ[t] <= T − H): CAERPᵢⱼ[t] = 0 |
| c. | Else: CAERPᵢⱼ[t] = CAERPᵢⱼ[t−1] |

In block 480, to enhance the preliminary CAER decision, voice activity detection (VAD) information 471 and 472 for the current channels i and j may be used to decide whether the CAER state of the pair (whether signals i and j are from the same acoustic environment) should be changed based on the preliminary decision. This is based on what has been noticed here that at least one of the users in a pair should be speaking for the preliminary decision to be trustable. Below, VADᵢ[t] and VADᵢ[t] are the binary voice activity decisions at time index t, and CAERᵢⱼ[t] is the final CAER decision for clients i and j at time step t.

a. If ((VADᵢ[t]=1) OR (VADᵢ[t]=1)) AND (CAERPᵢⱼ[t]=1): CAERᵢⱼ[t]=1
b. Else if ((VADᵢ[t]=1) OR (VADᵢ[t]=1)) AND (CAERPᵢⱼ[t]=0): CAERᵢⱼ[t]=0
c. Else: CAERᵢⱼ[t]=CAERᵢⱼ[t−1]

In block 490, the different conference clients, based on their respective audio signals, are grouped to appropriate groups. This may be done by considering the situation as an evolving undirected graph with the clients as the vertices and the CAERᵢⱼ[t] decisions specifying whether there are edges between the vertices corresponding to clients i and j. At each time step, the clients may be grouped by finding the connected components of the resulting graph utilizing e.g. depth-first search (DFS).

Below, some of the blocks in FIG. 4 are elaborated.

For blocks 411 and 412 (MFCC computation), the following may be applied. First, an N-point discrete Fourier transform (DFT) may be computed, e.g. using a fast Fourier transform (FFT) algorithm of a signal frame x[n]:

$$X [ k ] = {\prod }_{n = 1}^{N - 1} x [ n ] \cdot {e}^{\frac{- j2 π nk}{N}} , k = 0 , 1 , … , N - 1$$

where n is the time index and k: is the frequency bin index. A filter bank of triangular filters may be defined as:

$$\text{?} [ k ] = \{ \begin{matrix}0 , & for & k < 0 \\ \frac{( k - \text{?} )}{( \text{?} - \text{?} )} , & for & \text{?} \leq k \leq \text{?} \\ \frac{( k - \text{?} )}{( \text{?} - \text{?} )} , & for & \text{?} \leq k \leq \text{?} \\ 0 , & for & k > \text{?}\end{matrix} , l = 1 , 2 , … , M \\ \text{?} \text{indicates text missing or illegible when filed}$$

where f_{b}_{₁} are boundary points of the filters, and k=1, 2, . . . , N corresponds to the k-th coefficient of the N-point DFT.

The transformation from a linear frequency scale to the Mel scale may be done e.g. as:

$$\text{?} = 1127 \cdot ln ( 1 + \frac{\text{?}}{700} )$$

$$\text{?} \text{indicates text missing or illegible when filed}$$

where fᵢᵢₙ is the frequency to be converted expressed in Hz.

The boundary points of the triangular filters above may be adapted to be uniformly spaced on the Mel scale. The end points of each triangular filter may be determined by the center frequencies of the adjacent filters.

The filter bank may consist of e.g. 20 triangular filters covering a certain frequency range (e.g. 0-4600 Hz). The center frequencies of the first filters can be set to be linearly spaced between e.g. 100 Hz and 1000 Hz, and the next ten filters to have logarithmic spacing of center frequencies:

$$\text{?} = \{ \begin{matrix}100 \cdot l , & l = 1 , … , 10 \\ \text{?} \cdot \text{?} , & l - 11 , … , 20\end{matrix} \\ \text{?} \text{indicates text missing or illegible when filed}$$

The MFCC coefficients may be computed as:

$$MFCC [ m ] = {\sum }_{l = 1}^{M} \text{?} \cdot cos ( m \cdot ( l - 0.5 ) \cdot \frac{π}{M} ) , m = 1 , 2 , … , K$$

$$\text{?} \text{indicates text missing or illegible when filed}$$

where X₁ is the logarithmic output energy of the l-th filter according to

Xₗ=log₁₀(Σₖ₌₀^{N-1}|X[k]|·Hᵢ[k]),l=1,2, . . . ,M.

In block 450, computing the correlation may happen as follows. A traditional equation for a correlation can be adapted to be used for the correlation computation. A correlation from sliding windows of N₁, latest liftered MFCC vectors of the two clients may be computed. The mean computed over the whole window is subtracted out. In the proposed approach, the sums over time are replaced with leakyintegrators (first order IIR filters). The cepstral mean subtraction (CMS, equation a of step 4), corresponding to subtracting the mean, is also performed using a leaky integrator. The CMS computes the time average for each coefficient separately and is synergistic with the property of cepstra that convolution becomes addition, which means that the static filter effect (e.g. different handsets that have different transfer functions) may be compensated.

Using equations a-d of block 450 has been noticed to reduce the amount of computation, providing an advantage of the proposed way of computation. The amount of computation saving may become even more pronounced if the possible delay differences in the signals are compensated for.

Other representations than mel-frequency cepstral coefficients may be used. For example, the following coefficients may be used:
Bark frequency cepstral coefficients (BFCC), where the triangular filter spacing is on the Bark auditory scale instead of the Mel scale. Any other spacing of the filters may be used as well.
Linear prediction coefficients (LPC)
Line spectral frequencies/pairs (LSF/LSP)
Discrete Fourier transform (DFT) as one or more of the transforms (practically computed with the fast Fourier transform (FFT) algorithm)
Wavelet transforms of any kind as at least one of the transforms such as discrete wavelet transform (DWT), or continuous wavelet transform (CWT)
Short-time energies of time-domain filter banks, such as Gammatone filter bank, filter bank with Equivalent Rectangular Band (ERB) spacing, or a filter bank with any frequency spacing (logarithmic, linear, auditory etc.)
a time-frequency representation
a (spectral) audio signal representation used in a speech or audio coding method.

A feature representation which is computed from short signal frames may be used.

MFCCs may have the advantage that they can be used for other things in the server (processing device) as well: for example, but not limited to, speech recognition, speaker recognition, and context recognition.

Many of the mentioned tasks can be done using MFCCs and some other features simultaneously.

A voice activity detection (VAD) used in the various embodiments may be described as follows. A short-term signal energy is compared with background noise level estimate. If the short-term energy is lower than or close to the estimated background noise level, no speech activity is indicated. The background noise level is continuously estimated by finding the minimum within a time window of recent frames (e.g. 5 seconds) and then scaling the minimum value so that the bias is removed. Another type of VAD may be used as well (e.g. GSM standard VAD, AMR VAD etc.)

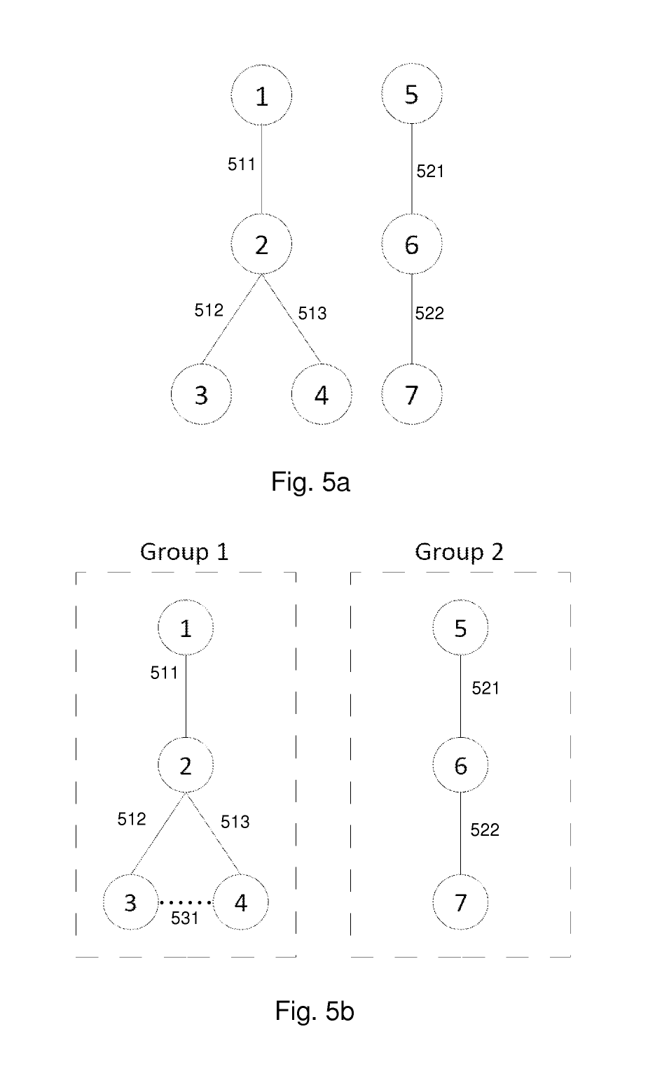

FIGS. 5a and 5b show the use of topology analysis according to an embodiment.

Once the common audio environment recognition values have been formed, the clients may then be clustered into one or more location groups based on their CAER indicators from block 490. Once proximity groups have been established, the conference server may initiate audio routing in the teleconference. That is, the conference server may begin receiving audio signals from each of the clients and routing the signals in accordance with the proximity groupings. In particular, audio signals received from a first client might be filtered from a downstream audio signal to a second client if the first and second clients are in the same proximity group or location.

A method for forming groupings with depth-first search will be explained next. Another method for finding the connected components of a graph may be used, also. In an undirected graph, each vertex (also known as node) represents a client/user and each edge represents a positive final CAER decision at the current time instant. The search starts from a first user and it moves from there along the branch as far as possible before backtracking. In the case of the example in FIG. 5a, starting from user 1, the method proceeds as follows:
We find that users 1 and 2 are connected 511, we store that information into a data structure (e.g. a list of clients/users in the group) and add users 1 and 2 to a list of visited users.
Then we find that 2 and 3 are connected 512, adding user 3 to the list of users in the group and visited users,
Next, we find that we can not get further in the branch, and then backtrack one step to user 2 and find that users 2 and 4 are connected 513, add user 4 to the group and list of visited users, find that we can not get further in the branch, and we backtrack to user 1 and find we can not get any further.
Users 1-4 are now in the list and therefore in the same group. They have also all been marked as visited.
Next, we start from the next user that doesn't belong to any group yet (that has not been visited yet), namely user 5.
We find that users 5 and 6 are connected 521, add them both to the list of users in group 2 and the list of visited users, and then we find that users 6 and 7 are connected 522, and add them similarly.
We backtrack to user 6 and find we can not get further and then find the same for user 5.
Now we know that users 5-7 are in the same group.
All users have been marked as visited and the grouping is complete for this time step.
The process is repeated at each time step or when at least one

CAER decision changes. There may be no need to do the grouping again until a CAER decision changes.

FIG. 5b represents the groups formed with the approach described above. Users 1, 2, 3 and 4 have been determined to belong to group 1 and users 5, 6 and 7 to group 2. It needs to be appreciated that using the graph-based group determination users that were not indicated by the CAER decisions may end up in the same group. Namely, since e.g. users 3 and 4 are both individually in the same acoustic environment with user 2, they belong to the same group, although their mutual CAER decision does not indicate so. This may be e.g. because they are too far from each other in the common space for the audio signals to be picked up by the other client microphone. This ability to form groups is an advantage of the graph-based method. It needs to be appreciated that the graph-based method may be used with other kinds of common audio environment indicators as the ones described. Also, the connections between the members of the group may be augmented based on the graph method. For example, a connection 531 may be added between users 3 and 4 indicating they are in the same audio environment.

In various embodiments, hysteresis may be applied to the grouping decisions. In other words, when the determination of a change in the status of two devices moving into or away from the same acoustic space is made, different thresholds for making the decision may be applied based on direction. This may make the method more stable and may thus enable e.g. faster operation of the method.

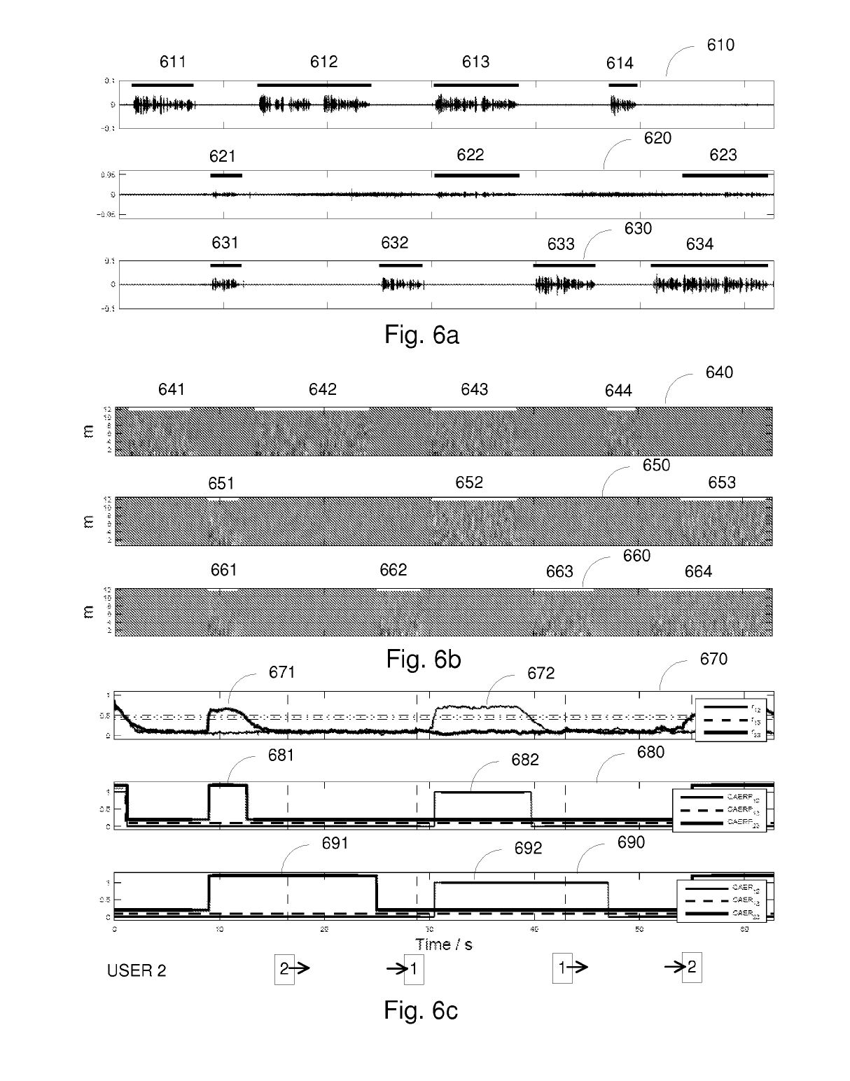

FIGS. 6a, 6b and 6c illustrate signal processing for controlling an audio conference according to an embodiment. The scenario is described first as follows. There are three users in two rooms. Users 1 and 3 are talking with each other over then phone (e.g. cell phone or VoIP call). Initially, users 2 and 3 are in room 2 and user 1 is in room 1. User 2 then moves along a corridor to room 1, and then back to room 2.

In FIG. 6a, audio signals from users/clients 1, 2 and 3 are shown in plots 610, 620 and 630, respectively. Plot 610 shows four sections 611, 612, 613 and 614 of voice activity, indicated with a solid line above the audio signal. Plot 620 shows three sections 621, 622 and 623 of detected voice activity, where section 622 coincides temporally with the section 613. Plot 630 shows four sections 631, 632, 633 and 634 of voice activity, where section 631 coincides temporally with section 621, and section 634 partially coincides with section 623. The movement of user 2 between rooms 1 and 2 has been indicated below FIG. 6c. The FIGS. 6a, 6b and 6c share the time axis and have been aligned with each other.

In FIG. 6b, MFCC features for users/clients 1, 2, and 3 are shown. Plot 640 shows MFCC features after liftering and cepstral mean subtraction, i.e, MFCC_{CMS}[m,t] above computed from the signal sent to the server from the device of user 1 or the time domain signal of user 1 at the server. The signal is captured by the microphone, possibly processed by the device of the user (with acoustic echo cancellation, noise reduction etc.), and then sent to the server, where the features are computed in short signal frames (e.g. 20 ms). A white line indicates the time sections that are classified as speech by the voice activity detector. That is, the time sections 641, 642, 643 and 644 of the plot 640 match the sections 611, 612, 613 and 614 for plot 610. Likewise, sections 651, 652, 653 of plot 650 correspond to sections 621, 622 and 623. Likewise, the time sections 661, 662, 663 and 664 of the plot 660 correspond to the sections 631, 632, 633 and 634. In the sections where there is voice activity, the MFCC coefficients are clearly different from the silent periods (shown in the grayscale plots 640, 650 and 660).

Plot 670 shows correlations computed from the three user pairs (1-2 as the thin line 672, 1-3 as the dashed line, and 2-3 as the thick line 671). There is a starting transient seen in the beginning. It is caused by the correlation computation and its effect is removed by the VAD when making the final decision (in this case, as the VAD is zero in the beginning for all clients). In plots 670, 680 and 690, the four vertical dashed lines show the time instants at which user 2 enters and leaves the rooms, that is, leaves room 2 (2→), enters room 1 (→1), leaves room 1 (1→), and enters room 2 (→2), respectively.

Plot 680 shows the preliminary CAER decisions for the three user pairs (1-2 as 682, 1-3, and 2-3 as 681). The decisions are binary—there is a vertical offset of 0.1 and 0.2, applied to the plots of the pairs 1-3 and 2-3, respectively, so that the decisions can be seen from the plot (for printing reasons only).

Plot 690 shows the final CAER decisions, which take into account the VAD information. From the plots one can see that the decision is changed only when there is speech activity at either client of the pair. For example, the decision for pair 2-3 (signal 691) changes from different to same space shortly before the 9 s mark when user 3 starts speaking and user 2 hears that. There is voice activity in the signals of both clients. The decision stays the same even when the preliminary decision changes to different space after user 3 stops speaking. This happens because VAD indicates no speech activity when the preliminary decision changes. However, later close to the 25 s mark, user 3 starts speaking again and the final decision is now changed to different space, as user 2 can not hear user 3 directly anymore. This decision was not made when both users are silent, because background noise alone is not enough to indicate whether the two users are in the same space, as is evident from the correlation plot.

Additional methods may be used to modify the common acoustic environment decision e.g. to improve robustness or accuracy. Some of these methods will be described next.

Delaying the decision when moving to a different space may be used as follows. When two clients are erroneously moved to a different acoustic space in a conference while the users are actually still in the same space, feedback can arise especially if speaker mode of mobile phones is used. In order to increase the robustness of the system against these situations, a certain amount of inertia may be added to the case where the CAER indicator is changed to zero. This may be accomplished by delaying the decision until a certain number of frames (e.g. two seconds), where the condition ((VADᵢ[n]=1 OR VADᵢ[n]=1) AND (CAERPᵢⱼ[n]=0)) is fulfilled, has been accumulated. This ensures that there is enough evidence before moving the clients to different groups and routing their audio streams to each other through the network.

The mis-synchronization of the audio signals may be handled as follows. If the signals captured at different users are not time-aligned, the correlation may be low and it may not be possible to reliably detect two users being in the same room. In order to counteract for this, it may be necessary to modify the method so that the correlation is also computed between delayed versions of the coefficients of a user pair, and then choosing the maximum value out of these correlations. The maximum lag for the correlation can be chosen based on the maximum expected mis-synchronization of the signals. This maximum lag may be dependent e.g. on the variation of network delay between clients in VoIP.

Handling the situations where mute is enabled may happen as follows. A problem may appear if conference participants activate mute on their devices. Mute prevents microphone signal to be correctly analyzed by the detection algorithm which may lead to false detection. For example, when participants A and B are in same acoustic space, and A activates mute on his device, the algorithm should not automatically group participants to different groups. If this happens, A will start to hear the voice of B (and his own voice) from the loudspeaker of his device, while his mute is on.

If the conferencing system supports explicit mute signaling between the client (device) and the server (conference bridge), the conference mixer can keep track which clients have activated mute and prevent changing groups when client has muted itself. Explicit mute signaling may comprise additional control signaling between client and the server. For example, in VoIP (Voice over Internet Protocol) conferencing e.g. SIP (Session Initiation Protocol) messages may be used. In this case, also when participant A activates mute, the conference server may activate mute for participant B which is in same acoustic space with A, preventing any previously mentioned problems taking place.

Avoiding wrong groupings may happen as follows. A solution to overcome groupings to wrong group may be to add automatic feedback detection functionality to the detection system. Whenever terminal is grouped wrongly (e.g. due to mute being switched on) causing feedback noise to appear, the feedback detector detects the situation and the client may be placed to the correct group. The feedback detector helps in situations where terminals are physically in the same acoustic space, but they are automatically grouped to a different group. Another embodiment is to monitor movement of user's device with other sensors (such as GPS or acceleration sensors), and transfer user from one group to other only if user or user device has been moving. This can prevent grouping errors of immobile users. It needs to be appreciated that the movement or position of a user device may be detected, and/or the movement of the user (e.g. with respect to the device) may be detected. Either or both results of detection may be utilized for grouping. Alternatively or in addition, movement or position determination of users may trigger the evaluation of grouping of users, or the grouping decision may make use of the movement and/or position information. Acoustic feedback caused by wrong grouping (that is, users/clients are placed into different conference groups by the system when in fact they are able to acoustically hear each other) may be a relevant problem when the speaker mode of the devices is used, that is, the loudspeaker of the devices sends a loud enough signal. When speaker mode is not used (e.g. as in normal phone usage or with a headset) there may still be audible echo, which can be disturbing as well, but feedback may be absent.

Double-talk information may be utilized as follows. One further option to improve the automatic grouping of participants may be to monitor when multiple talkers are talking at the same time. In these situations there is higher probability for detection and grouping errors, since device-based acoustic echo control may not perform optimally. The main case is a double-talk situation when local and remote participants are talking at the same time. One possibility is to prevent automatic changing of groups when double-talk is present.

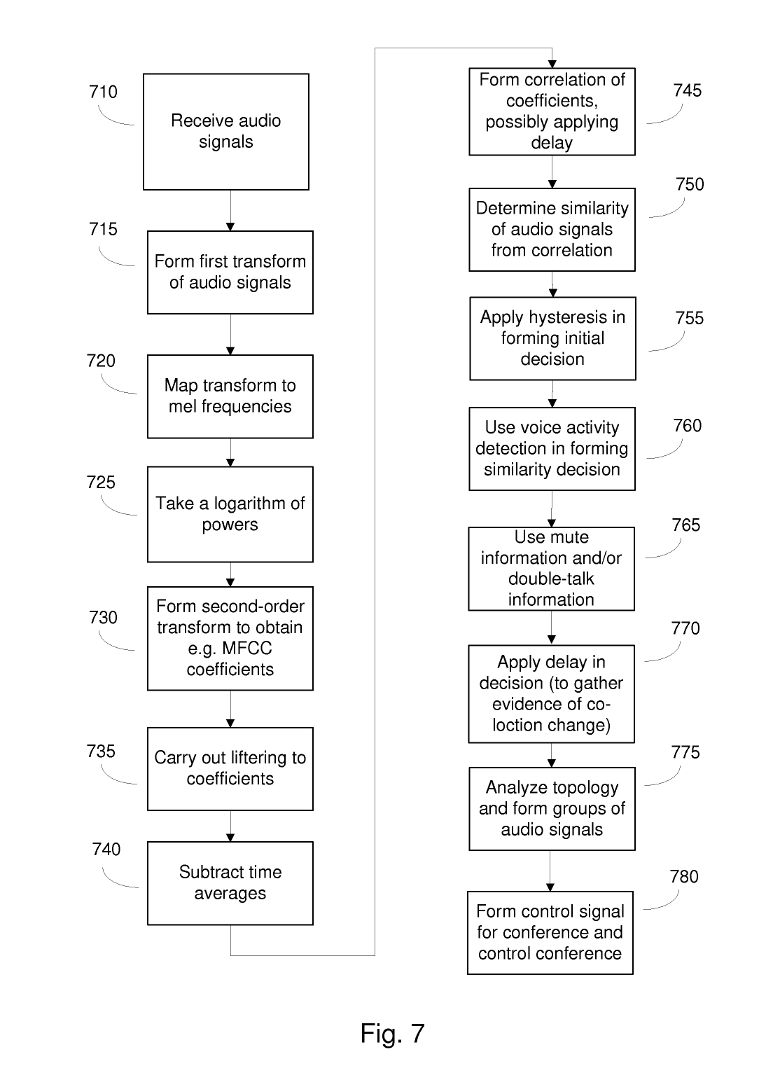

FIG. 7 shows a flow chart for a method for audio conferencing according to an embodiment.

In phase 710, audio signals may be received e.g. with the help of microphones and consequently sampled and digitized so that they can be digitally processed. In phase 715, a first transform such as a discrete cosine transform or a fast Fourier transform may be formed from the audio signals (e.g. one transformed signal for each audio signal). Such a transform may provide e.g. a power spectrum of the audio signal. In phase 720, the transform may be mapped in the frequency domain to new frequencies e.g. by using mel scaling as described earlier. A logarithm may be taken of the powers of the mapped spectrum in phase 725. A second-order transform such as a discrete cosine transform may be applied to the first transform (as if the first transform were a signal) in phase 730 e.g. to obtain coefficients such as MFCC coefficients. The transforms may be carried out partly or completely at the mobile devices where the audio signal is captured, and/or it may be carried out at a central computer such as an audio conference server. The coefficients from the second-order transform are then received for processing in phase 735.

In phase 735, liftering may be applied to the coefficients to scale them to be more suitable for similarity determination later in the process. In phase 740, time averages of the liftered coefficients may be subtracted to remove any static differences e.g. in microphone pick-up functions.

In phase 745, the coefficients are used to determine similarity between the audio signals from which they originate e.g. by computing a correlation and determining the preliminary signal similarity in phase 750. The similarity may indicate the presence of two devices in the same acoustic space. The similarity may be formed as a pair-wise correlation between two sets of transform coefficients, or another similarity measure such as a normalized dot product or normalized or unnormalized distance of any kind. The similarity may be given e.g. as a number varying between 0 and 1. A delay may be applied in computing the correlation, e.g. as follows. The feature vectors may be stored in a circular buffer (2-D array) and the correlation between the latest vector of client i and all stored vectors of client j (the delayed ones and the latest one) may be computed. The same process may then be applied with the clients switched. Now the maximum out of these correlation values may be taken as the correlation between clients i and j for this time step. This may compensate for the delay difference between the audio streams of the two clients.

In phase 755, hysteresis may be applied in forming the initial decision on co-location/grouping as described earlier in the context of phase 460. This may improve stability of the system.

In phase 760, voice activity information may be used in enhancing or forming the similarity information. In phase 765, other information such as mute information and/or double-talk information may be used to enhance the similarity signal. Delay may be applied in phase 770 for delaying the final decision when moving clients/users in a pair to different groups. That is, in phase 770, evidence of pair state change may be gathered over a period of time longer than one indication in order to improve the robustness of decision making.

In phase 775, graph analysis and topology information may be used in forming groups of the audio signals and the clients/users/terminals as described earlier in the context of FIGS. 5a and 5b.

Finally, in phase 780, a control signal is formed from the similarity so that an audio conference may be controlled using the control signal. For example, a binary value whether two devices are in the same acoustic space may be given, and this value may then be used to suppress the audio signals from these devices to each other to prevent unwanted behavior such as unwanted audio feedback.

The various embodiments described above may provide advantages. For example, existing VoIP and mobile conference call mixers may be updated to support automatic room recognition. This may allow distributed conferencing experience using mobile devices (FIG. 3b, location C). Furthermore, the embodiments may offer new opportunities with mobile augmented reality communication. The method may be advantageous also in the sense that for detecting common environment, the algorithm does not need a special beacon tone to be sent into the environment. The algorithm has also been noticed to be robust, e.g. it may tolerate some degree of timing difference (e.g. two or three 20 ms frames) between audio streams. It has been noticed here that if the delay is compensated in the correlation computation (as described earlier), the algorithm may be able to tolerate longer delay differences.

The various embodiments of the invention can be implemented with the help of computer program code (e.g. microcode) that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-52. (canceled)

53. A method, comprising:
receiving first and second second-order spectrum coefficients for a first audio signal from a first device and a second audio signal from a second device;
determining a similarity of said first and second-order spectrum coefficients, and
forming a control signal using said similarity, said control signal for controlling audio conferencing.

54. A method according to claim 53, comprising:
receiving a first audio signal from a first device and a second audio signal from a second device,
computing first and second power spectrum coefficients from said first and second audio signals, respectively, by applying a transform to said audio signals,
computing first and second second-order spectrum coefficients from said first and second power spectrum coefficients, respectively, by applying a transform to said power spectrum coefficients,
determining a similarity of said first and second second-order spectrum coefficients, and
using said similarity in controlling said conferencing.

55. A method according to claim 53, wherein said second-order spectrum coefficients are mel-frequency cepstral coefficients.

56. A method according to claim 53, comprising:
scaling said second-order spectrum coefficients with an increasing function so that values of higher-order coefficients are increased more than values of lower-order coefficients.

57. A method according to claim 56, wherein said function is a liftering function, and said coefficients are scaled according to equation Cscaled=Coriginal*k̂a, where Cscaled is the scaled coefficient value, Coriginal is the original coefficient value, k is the order of the coefficient and a is an exponent such as 0.4.

58. A method according to claim 53, comprising:
omitting at least one second-order spectrum coefficient in determining said similarity, said omitted coefficient being indicative of a long-term mean power of said signals.

59. A method according to claim 53, comprising:
determining said similarity by computing a forgetting time-average of a dot product between said first and second second-order spectrum coefficients.

60. A method according to claim 53, comprising:
computing time averages of said first and second second-order spectrum coefficients,
subtracting said time averages from said second-order spectrum coefficients prior,
using the subtracted coefficients in determining said similarity.

61. A method according to claims 53, comprising:
forming an indication of co-location of said first and said second device using said similarity,
controlling said conferencing so that said co-location is taken into account in processing said first and second audio signals for said first and second device.

62. An apparatus comprising at least one processor, memory, operational units, and computer program code in said memory, said computer program code being configured to, with the at least one processor, cause the apparatus at least to:
receive first and second second-order spectrum coefficients for a first audio signal from a first device and a second audio signal from a second device;
determine a similarity of said first and second second-order spectrum coefficients, and
form a control signal using said similarity, said control signal for controlling audio conferencing.

63. An apparatus according to claim 62, comprising computer program code being configured to cause the apparatus to:
receive a first audio signal from a first device and a second audio signal from a second device,
compute first and second power spectrum coefficients from said first and second audio signals, respectively, by applying a transform to said audio signals,
compute first and second second-order spectrum coefficients from said first and second power spectrum coefficients, respectively, by applying a transform to said power spectrum coefficients,
determine a similarity of said first and second second-order spectrum coefficients, and
use said similarity in controlling said conferencing.

64. An apparatus according to claim 62, comprising computer program code being configured to cause the apparatus to:
scale said second-order spectrum coefficients with an increasing function so that values of higher-order coefficients are increased more than values of lower-order coefficients.

65. An apparatus according to claim 64, wherein said function is a liftering function, and said coefficients are scaled according to equation Cscaled=Coriginal*k̂a, where Cscaled is the scaled coefficient value, Coriginal is the original coefficient value, k is the order of the coefficient and a is an exponent such as 0.4.

66. An apparatus according to claim 65, comprising computer program code being configured to cause the apparatus to:
omit at least one second-order spectrum coefficient in determining said similarity, said omitted coefficient being indicative of a long-term mean power of said signals.

67. An apparatus according to claim 62, comprising computer program code being configured to cause the apparatus to:
determine said similarity by computing a forgetting time-average of a dot product between said first and second second-order spectrum coefficients.

68. An apparatus according to claim 62, comprising computer program code being configured to cause the apparatus to:
compute time averages of said first and second second-order spectrum coefficients,
subtract said time averages from said second-order spectrum coefficients prior,
use the subtracted coefficients in determining said similarity.

69. An apparatus according to claim 62, comprising computer program code being configured to cause the apparatus to:
form an indication of co-location of said first and said second device using said similarity,
control said conferencing so that said co-location is taken into account in processing said first and second audio signals for said first and second device.

70. An apparatus according to claim 69, comprising computer program code being configured to cause the apparatus to:
use information from a voice activity detection of at least one audio signal in forming said indication of co-location.

71. An apparatus comprising:
means for receiving first and second second-order spectrum coefficients for a first audio signal from a first device and a second audio signal from a second device;
means for determining a similarity of said first and second second-order spectrum coefficients, and
means for forming a control signal using said similarity, said control signal for controlling audio conferencing.

72. A computer program product stored on a non-transitory computer readable medium and executable in a data processing apparatus, the computer program product comprising:
a computer program code section for receiving first and second second-order spectrum coefficients for a first audio signal from a first device and a second audio signal from a second device;
a computer program code section for determining a similarity of said first and second second-order spectrum coefficients, and
a computer program code section for forming a control signal using said similarity, said control signal for controlling audio conferencing.
